(19) United States
(12) Patent Application Publication
(10) Pub. No.: US 2026/0350128 A1
(43) Pub. Date: Nov. 5, 2026

(54) Autonomous Behavior Detection, Service Containerization, and Smart Contract Bridging in Sealed Systems

(71) Applicant: ADRIAN FARIAS JARAMILLO, JURUPA VALLEY, CA (US)

(72) Inventor: ADRIAN FARIAS JARAMILLO, JURUPA VALLEY, CA (US)

(21) Appl. No.: 19/336,220

(22) Filed: Sep. 22, 2025

Related U.S. Application Data
(63) Continuation of application No. 19/197,894, filed on May 2, 2025.
(60) Provisional application No. 63/786,937, filed on Apr. 10, 2025.
(60) Provisional application No. 63/787,944, filed on Apr. 13, 2025.
(60) Provisional application No. 63/788,834, filed on Apr. 15, 2025.
(60) Provisional application No. 63/791,534, filed on Apr. 20, 2025.
(60) Provisional application No. 63/792,918, filed on Apr. 23, 2025.

(51) Int. Cl. G06F 21/31

(52) U.S. Cl. CPC G06F 21/316

(57) ABSTRACT

A sealed execution system incorporating behavior detection, smart contract bridging, and service containerization. Autonomous actions and smart contracts are allowed only when behavior scores meet thresholds and containers pass verification. Execution is denied if origin, metadata, or contract conditions fail compliance checks. The system ensures rule-bound fulfillment, audit trails, and post-task enforcement within platform governance.

### CROSS-REFERENCE TO RELATED APPLICATIONS

This application is a continuation of U.S. Utility Patent Application No. Ser. No. 19/197,894, filed May 2, 2025, which claims the benefit of the following U.S. Provisional Patent Applications, each of which is incorporated herein by reference in its entirety:
U.S. Provisional Application No. 63/786,937, filed Apr. 10, 2025, titled “System and Method for Buyer-Initiated Marketplace Transactions Across Multiple Industries”
U.S. Provisional Application No. 63/787,944, filed Apr. 13, 2025, titled “Sealed Toolset and Logic Framework for Buyer-Initiated Offer Systems”
U.S. Provisional Application No. 63/788,834, filed Apr. 15, 2025, titled “Toolset Protection for Modular Buyer-Initiated Offer Ecosystem”
U.S. Provisional Application No. 63/791,534, filed Apr. 20, 2025, titled “Modular Toolset Architecture for Multi-Sector Buyer-Initiated Commerce Infrastructure”
U.S. Provisional Application No. 63/792,918, filed Apr. 23, 2025, titled “Lockdown: Final Enforcement Tools for Global Buyer-Initiated Transaction Control”

### FIELD OF THE INVENTION

The present invention relates generally to platform-governed execution systems and, more particularly, to the enforcement of execution control using autonomous behavior analysis, modular service containers, and smart contract bridges within sealed fulfillment rails.

### BACKGROUND OF THE INVENTION

Existing platforms allow fragmented services to operate across decentralized or unverified environments, resulting in data leakage, misaligned behaviors, and trust failures.

Smart contracts are used in decentralized systems but lack integration with platform-bound trust triggers, escrow logic, or compliance enforcement.

There is a need for a sealed, centralized infrastructure that supports intelligent behavior monitoring, dynamic execution segmentation, and compliant interoperability with smart contract ecosystems.

### SUMMARY OF THE INVENTION

This invention introduces a behavior-aware execution controller that identifies, scores, and enforces compliant actions within the sealed platform.

Each fulfillment request is routed through behavior filters and dynamically packaged into service containers that comply with platform rules, jurisdictions, and licensing tiers.

Smart contract bridges validate and approve externally-originating logic only when tethered to platform trust anchors.

Execution is blocked when autonomous agents or smart contracts attempt fulfillment without sealed verification.

### BRIEF DESCRIPTION OF THE DRAWINGS

FIG. 1 Is a block diagram illustrating an audit trail generation module embedded within a platform-governed transaction system, wherein all fulfillment signals are indexed to immutable metadata records. Elements include [1701] transaction signal input, [1702] metadata encoder, platform timestamp authority, and [1704] ledger commitment engine.

FIG. 2 Is a schematic diagram illustrating a compliance enforcement overlay wherein jurisdictional filters are dynamically applied to execution pathways based on metadata flags. Elements include [1705] jurisdictional filter bank, [1706] metadata trigger queue, [1707] compliance decision core, and [1708] execution permit relay.

FIG. 3 Is a diagram illustrating post-fulfillment compliance triggers and autonomous enforcement flows for sealed transactions, incorporating robotic or AI-driven actions and jurisdictional compliance response modules. Elements include [1709] post-fulfillment sensor input, [1710] AI compliance arbiter, [1711] enforcement module selector, and [1712] sealed action lockout circuit.

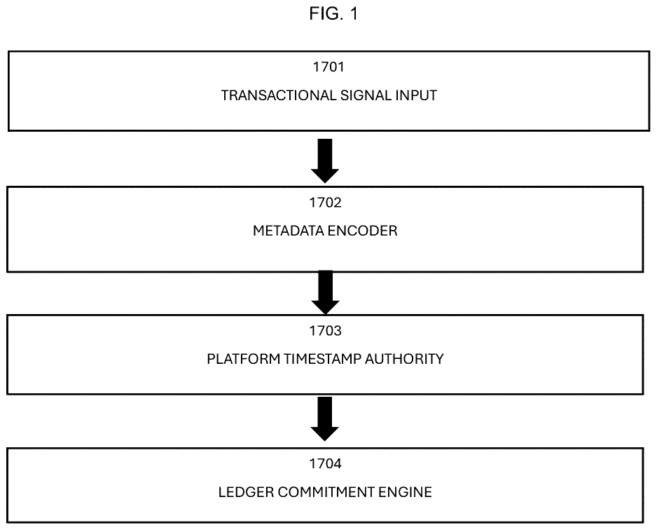

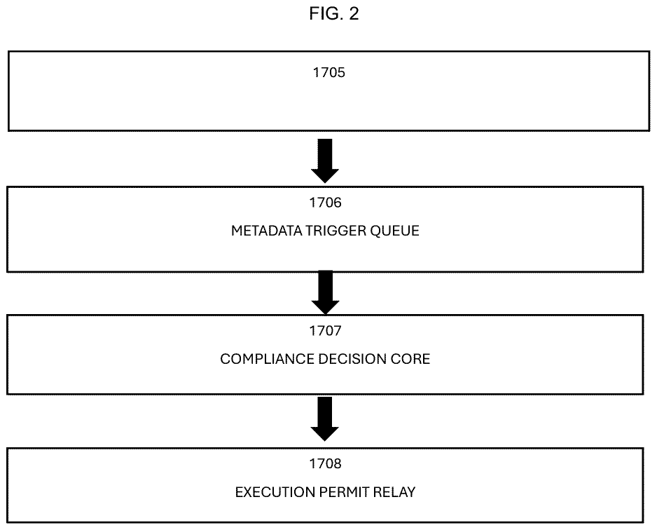

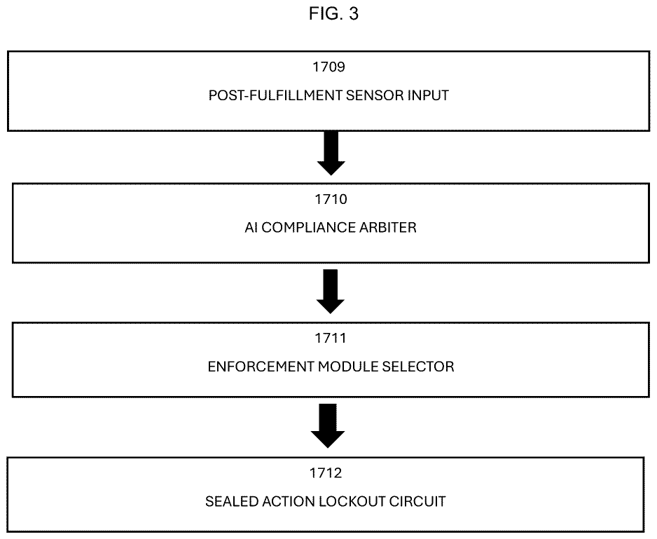

Each figure is uniquely identified by labels beginning at element 1701 and proceeding sequentially through element 1712, and each figure is distinct from those disclosed in FIGS. 0-12 of the master utility patent and prior continuations.

### DETAILED DESCRIPTION OF THE INVENTION

The system includes a behavior detection engine monitoring session patterns, interaction frequency, timing anomalies, and metadata correlations.

Detected behaviors are scored and classified into risk tiers. High-risk or unlicensed behavior is blocked.

Each transaction request is encapsulated into a service container containing logic permissions, jurisdiction filters, trust credentials, and escrow pathways.

The service container ensures segmented execution that cannot be repurposed or reused across unauthorized platforms.

Smart contracts originating from external ecosystems must be submitted through a platform-controlled bridge.

This bridge verifies metadata, checks token origin, enforces execution limits, and applies jurisdiction filters.

Fulfillment attempts that bypass behavior scoring, container logic, or smart contract bridging are automatically denied.

Platform compliance logs include timestamps, behavioral scores, contract IDs, and rule-based outcomes.

Autonomous agents or robotic systems are restricted unless fully licensed and metadata-tethered to platform trust modules.

Service segmentation supports temporary, recurring, or conditional logic, allowing secure deployment and post-fulfillment control.

The platform integrates sealed governance over all behavior-triggered fulfillment, ensuring sealed, licensed, and rule-compliant execution.

What is claimed is:

1. A system comprising:
a behavior detection engine, a trust scoring module, and a fulfillment controller that blocks execution unless behavior scores meet compliance thresholds.

2. The system of claim 1, wherein metadata anomalies, timing inconsistencies, or repetitive input are used to adjust behavior scores.

3. The system of claim 1, wherein autonomous systems must be registered and bound to licensed platform trust modules before triggering fulfillment.

4. A system comprising:
dynamic service containers configured to encapsulate logic permissions, jurisdiction filters, and execution limits.

5. The system of claim 4, wherein service containers are automatically created for each fulfillment trigger and destroyed upon task completion.

6. A platform-licensed smart contract bridge comprising:
an input validator, token origin checker, compliance filter, and rule enforcement logic.

7. The system of claim 6, wherein smart contracts lacking metadata validation or license anchoring are denied execution.

8. The system of claim 4, wherein container metadata includes: originating IP, jurisdictional profile, and session behavior log.

9. A method comprising:
detecting user or agent behavior;
scoring the behavior against platform compliance rules;
and allowing execution only if scores meet predefined thresholds.

10. A system of claim 1, further comprising a risk-response engine that routes high-risk triggers to sandboxed execution environments.

11. The system of claim 6, wherein smart contracts must pass escrow validation before any offer can be generated.

12. A platform-compliance engine comprising:
behavior score thresholds, contract bridge controls, and jurisdictional lockdown filters.

13. The system of claim 1, wherein robotic fulfillment agents are verified using embedded platform-authenticated modules.

14. A fulfillment method comprising:
encapsulating a service logic request into a container;
verifying metadata and origin;
applying execution segmentation rules; and logging outcomes.

15. The system of claim 4, wherein recurring service containers include auto-expiration rules and license revalidation intervals.

16. The system of claim 1, wherein fulfillment is denied if behavioral anomalies or external agent signatures are detected.

17. A method for enforcing post-fulfillment compliance comprising:
logging container actions, scoring post-execution behavior, and triggering enforcement if deviations are detected.

18. The system of claim 6, wherein smart contracts must route through a sealed interface with token-bound execution ID tracking.

19. The method of claim 9, wherein behavior scores dynamically update based on post-fulfillment trust outcomes.

20. A sealed fulfillment system comprising:
autonomous behavior filters, smart contract validation bridges, service containers, and metadata-based execution locks.

21. The system of claim 15, wherein an autonomous actor is blocked from initiating fulfillment unless a pre-action behavioral confirmation sequence is logged by the platform.

22. The system of claim 16, wherein post-fulfillment metadata must match the sealed escrow parameters before a robotic actor is authorized to finalize any delivery.

23. The system of claim 17, wherein an AI agent's execution request is denied if its interaction pattern deviates from a learned trust-compliant baseline.

24. The system of claim 18, wherein platform rules require a post-action audit trail including timestamps, sensor input, and trigger origin before fulfillment is certified.

25. A system for governing post-fulfillment activity executed by autonomous or robotic actors, comprising:
a platform-verified trigger input;
a fulfillment log recording trust-verified task execution;
a behavioral compliance engine evaluating actor patterns against predefined fulfillment parameters;
wherein the system invalidates any fulfillment instance initiated or completed outside platform-certified behavioral rules.

26. The system of claim 25, wherein the behavioral compliance engine includes deviation pattern scoring, and fulfillment is blocked if the score exceeds a trust variance threshold.

27. The system of claim 25, wherein the fulfillment log requires embedded real-time telemetry, including positional drift, speed variance, and task confirmation inputs, for audit validation.

28. The system of claim 26, wherein the trust variance threshold is dynamically recalibrated based on prior session outcomes, environmental data, and actor-specific trust profiles.

29. The system of claim 1, wherein enforcement engines restrict unauthorized fulfillment by validating audit trail metadata prior to license issuance.
